(19) United States
(12) Patent Application Publication
(10) Pub. No.: US 2010/0072016 A1
(43) Pub. Date: Mar. 25, 2010

(54) Mechanical Clutch for V-Belt System

(76) Inventors: Brian Aschenbrenner, Franklin, WI (US); Guy R. Campbell, West Bend, WI (US)

Correspondence Address: BOYLE FREDRICKSON S.C., 840 North Plankinton Avenue, MILWAUKEE, WI, 53203, US

(21) Appl. No.: 12/548,207

(22) Filed: Aug. 26, 2009

Related U.S. Application Data
(60) Provisional application No. 61/091,922, filed on Aug. 26, 2008.

(51) Int. Cl. F16D 27/14

(52) U.S. Cl. 192/40; 192/84.9

(57) ABSTRACT

A mechanical clutch for use in a belt driven system requiring belt tensioning. The clutch includes a central shaft to be coupled to a rotating shaft, a first pulley rotationally and axially coupled to the central shaft, and a second pulley rotationally coupled to the central shaft configured to move axially relative to the first pulley along the central shaft. The clutch further includes an actuating mechanism configured to impart linear axial movement to the first pulley based on rotational input.

### CROSS-REFERENCE TO RELATED APPLICATIONS

This application claims the benefit of U.S. Provisional Application No. 61/091,922, filed Aug. 26, 2008, hereby incorporated by reference in its entirety.

### STATEMENT REGARDING FEDERALLY SPONSORED RESEARCH OR DEVELOPMENT

### Background

The present invention relates to a clutch for a v-belt system. More particularly, the present invention relates to a mechanical clutch configured as a shaft mounted mechanical device that will activate and deactivate a v-belt system that connects two or more pulleys.

V-belt systems and tensioning systems are often used for driving tools in outdoor power tools such as snow blowers, seeders, trowels, ground drive systems for walk behind equipment, tillers, aerators, small machinery, etc. Manufacturers of these devices are provided with a bag of parts to assemble the tensioner in situ in the v-belt system during the assembly of the device. This assembly process is often time consuming and difficult.

In a v-belt system, a belt is a looped strip of flexible material, used to mechanically link two or more rotating shafts. They may be used as a source of motion, to efficiently transmit power, or to track relative movement. Belts are looped over pulleys. In a two pulley system, the belt can either drive the pulleys in the same direction, or the belt may be crossed, so that the direction of the shafts is opposite.

In a v-belt system, the “V” shape of the belt tracks in a mating groove in the pulley (or sheave), with the result that the belt cannot slip off. The belt also tends to wedge into the groove as the load increases—the greater the load, the greater the wedging action—improving torque transmission and making the v-belt an effective solution to problems with slippage and alignment.

In a v-belt system, some mechanism is required for activating and deactivating the system. One method of activating the system is to tension a slack v-belt in engagement with a drive or driven pulley. Traditionally, this tension is provided by a manually activated tensioner such as an idler pulley located between the drive and driven pulleys that can be adjusted to increase the tension on the belt. This type of system includes the tensioner as a separate component, increasing system expense, assembly time, potential points of failure, etc.

What is needed is a mechanical clutch configured as a shaft mounted mechanical device that will manually activate and deactivate a v-belt system that connects two or more pulleys. What is further needed is such a clutch configured to include a mechanical and/or electro-mechanical switch converting rotational energy into linear energy to drive the clutch to activate and deactivate the v-belt system.

### BRIEF SUMMARY

According to a first aspect, a mechanical clutch for use in a belt driven system that requires a central shaft to be coupled to a rotating shaft, a first pulley rotationally and axially coupled to the central shaft, and a second pulley rotationally coupled to the central shaft configured to move axially relative to the first pulley along the central shaft. The clutch further includes an actuating mechanism that imparts linear axial movement to the first pulley based on rotational input. The actuating mechanism may be a ball ramp mechanism. Further, the rotating shaft may be an engine driven shaft driving the central shaft or the rotating shaft is a tool driving shaft driven by the central shaft. The ball ramp mechanism may additionally include an actuator plate configured to receive a rotational input. The ball ramp mechanism may be configured to convert the rotational input into linear movement along the axis of the central shaft. The actuator plate may be coupled to an electromechanical input providing the rotational input.

The central shaft may be configured to receive a splined rotating shaft.

These particular features and advantages may apply to only some embodiments falling within the claims and thus do not define the scope of the invention. The following description and figures illustrate a preferred embodiment of the invention. Such an embodiment does not necessarily represent the full scope of the invention, however. Furthermore, some embodiments may include only parts of a preferred embodiment. Therefore, reference must be made to the claims for interpreting the scope of the invention.

### BRIEF DESCRIPTION OF THE DRAWINGS

FIG. 1 is a longitudinal view of a mechanical clutch for activating and deactivating a v-belt system;

FIG. 2 is an transverse view of the mechanical clutch of FIG. 1;

FIG. 3 is an isometric view of the mechanical clutch of FIGS. 1 and 2;

FIG. 4 is an exploded view of the mechanical clutch of FIGS. 1-3; and

FIG. 5 is a longitudinal view of dethatcher including the mechanical clutch of FIGS. 1-4.

### DETAILED DESCRIPTION

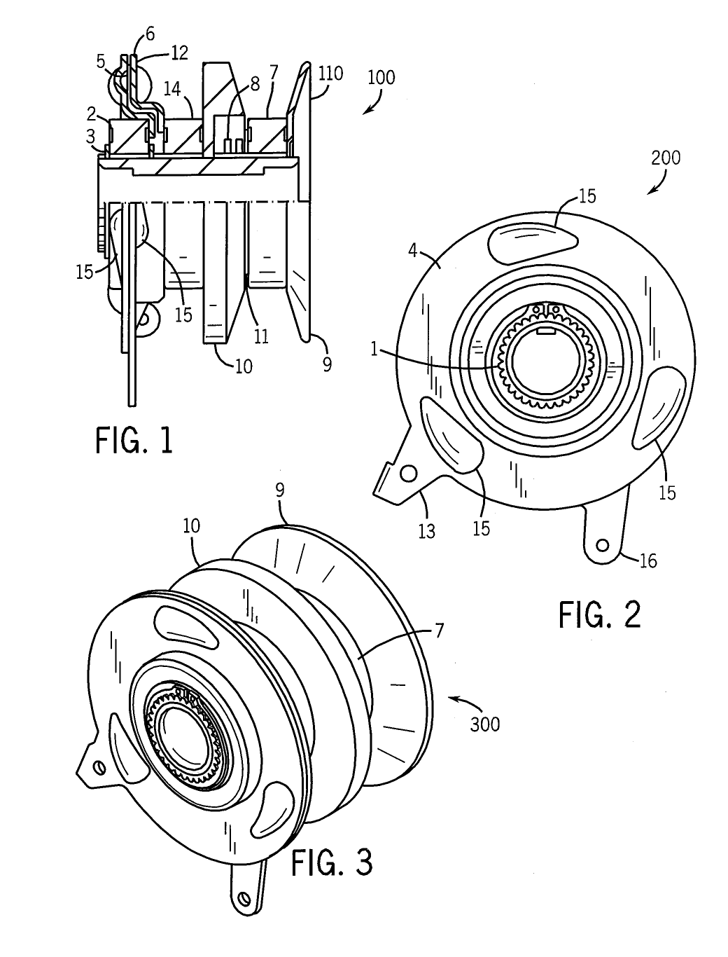

Referring now to FIGS. 1-3 and initially to FIG. 1 in particular, a longitudinal view 100 of a mechanical clutch 110 for activating and deactivating a v-belt system (not shown) is shown, according to an exemplary embodiment. In the exemplary embodiment, clutch 110 may be configured for use in belt tensioning applications incorporating engines of 7 horsepower or less. Although shown and described with reference to such applications, one of ordinary skill in the art would understand that the described mechanical clutch may be used with a variety of engine types of varying horsepower in a variety of application, consistent with the description herein.

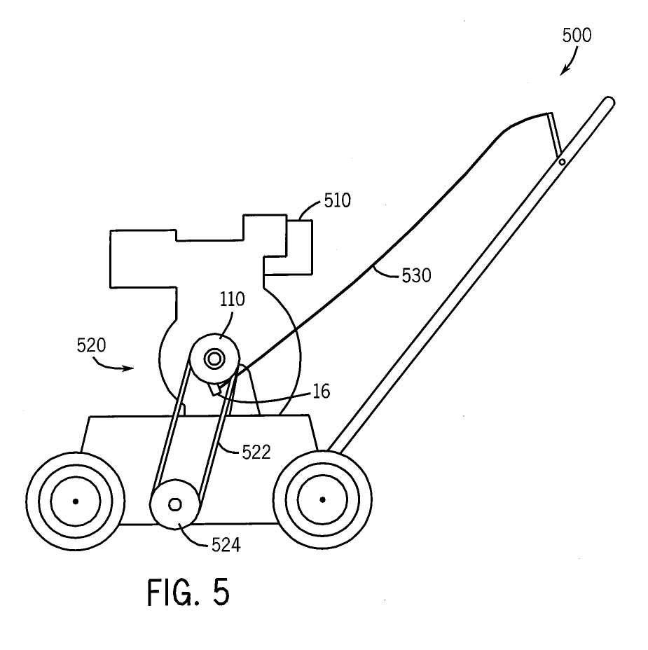

Clutch 110 is a shaft mounted mechanical device that will activate and deactivate a v-belt system that connects two or more pulleys, as described in further detail below with reference to FIG. 5. Clutch 110 includes a first pulley half 9, a bearing 7, a washer 11, a second pulley half 10, a spring 8, a second bearing 2, a ball ramp actuator mechanism 12, a third bearing 14, and a retaining ring 3 configured to anchor the components of clutch 110.

The first and second pulley halves 9 and 10 of mechanical clutch 110 are configured to engage the v-belt of a v-belt system riding on a ball bearing 7 positioned between the two pulley halves. First pulley half 9 is fixed to the end of a longitudinal shaft 1, shown and described in further detail below with reference to FIG. 2. First pulley half 9 is fixed both rotationally and axially to shaft 1 such that pulley half 9 will rotate in conjunction with shaft 1. Second pulley half 10 is also rotationally fixed to shaft 1 such that pulley half 10 will also rotate in conjunction with shaft 1. In the illustrated embodiment, central shaft 1 and pulley halves 9 and 10 are splined together to provide the rotational coupling.

Although pulley half 10 is rotationally coupled to shaft 1, pulley half 10 is configured to move axially along the central shaft 1.

Ball ramp actuator mechanism 12 is configured to impart linear motion to second pulley half 10 to move second pulley half 10 axially along shaft 1 to engage or disengage the clutch. When pulley halves 9 and 10 are moved close together, the v-belt of a v-belt system will become taut, activating the v-belt system. At this time, all pulleys connected with the v-belt within the belt system will move. When second pulley half 10 is moved away from first pulley half 9, the belt becomes loose, such that the belt will not rotate. It will instead simply rest on the ball bearing 7.

Ball ramp actuator mechanism 12 includes three balls 5 (one shown in FIG. 1), sandwiched between a first actuator plate 6 and a second anchored plate 4. Anchored plate 4 includes an anchoring point 13 (shown and described below with reference to FIG. 2) that prevents plate 4 from rotating. Plate 4 supported on central shaft 1 via a third bearing 15. Plate 6 rotates with central shaft 1 such that, as plate 6 rotates, it will move axially away from plate 4 under operation of the ball and ramp mechanism 12 as detailed below in conjunction with FIG. 2 and drive second pulley 10 axially along central shaft 1. This axial motion moves second pulley half 10 closer to first pulley half 9 and engages the v-belt system.

Referring now to FIG. 2, plate 4 of ball and ramp mechanism 12 includes a plurality of ball ramp grooves 15 housing balls 5. Ball ramp grooves 15 are configured in a tear drop shape such that, as balls 5 roll from a wide end to a narrow end of groove 15, balls 5 will extend further away from plate 4. Plate 6 may be configured to include grooves 15 positioned in an opposite orientation. Plate 4 and 6 may be configured such that when plate 6 is rotated relative to plate 4, the balls 5 are pushed to the narrow ends of grooves 15 of both plates to drive the plates apart increase the distance between plates 4 and 6.

Still referring to FIG. 2, an actuator anchor point 16 on plate 6 is configured to mate with a clutch engaging mechanism (not shown) that is configured to impart rotational motion to plate 6. The clutch engaging mechanism may be mechanical, such as a lever, or electromechanical, such as a solenoid, rotational motion. The rotational motion of plate 6 is converted to linear motion within clutch 100 by operation of the ball and ramp mechanism 12 to engage the v-belt system.

Advantageously, clutch 110 does not require original equipment manufacturers to assemble a plurality of parts to provide belt tensioning since there is not separate tensioning system. The belt tensioning function of clutch 100 may be used in lieu of existing system requiring manual tensioning and extensive alignment.

Clutch 110 may further be configured to include a scrub brake, not shown, positioned between first pulley half 9 and second pulley half 10 to engage the belt of the v-belt system when clutch 110 is disengaged. The scrub brake may be configured to engage the belt to prevent disengagement and/or movement of the belt relative to ball bearing 7 when clutch 110 is disengaged.

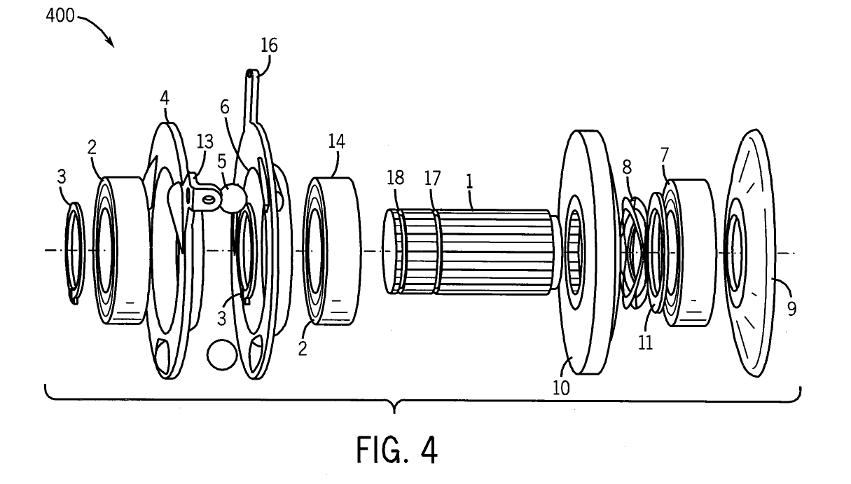

Referring now to FIG. 4, the coupling and orientation of the components of clutch 100 are illustrated in further detail. First pulley half 9 is configured to be axially and rotationally fixed to central shaft 1 by welding, staking or other similar fastening techniques. First pulley half 9 includes a flat side and an extending side, the extending side configured to extend such that the angle of the extending side matches the v-shape of the v-belt. A spring 8 may be used to maintain compression between plates 4 and 6 to prevent the balls from exiting grooves 15. Spring 8 may also be used to return clutch 110 to the disengaged position. Central shaft 1 may be configured to include a first retaining ring groove 17 configured to receive a retaining ring 3 and a second retaining ring groove 18 that receives a retaining ring 3.

Referring to FIGS. 1-4, bearing 2 nests in plate 4 to separate the rotating central shaft 1 from the fixed plates 4 and 6. Bearing 14 may be used to separate the rotating movement of pulley 10 from the rotationally independent plate 6.

Referring now to FIG. 5, a longitudinal view 500 of a dethatcher 510 including the mechanical clutch 110 for activating and deactivating a v-belt system 520 to drive the dethatcher 510 is shown. Although one particular tool is shown including clutch 110 in a specific configuration, it should be understood by one of ordinary skill in the art that clutch 110 may be used in a variety of configurations in a variety of applications consistent with the teachings herein. V-belt system 520 includes a v-belt 522 coupled to a driven pulley 524 that drives a dethatching tool of detacher 510. Mechanical clutch 110 is shown coupled to the engine of dethatcher 510 such that clutch 110 drives the v-belt 522 of v-belt system 520 when engaged. Dethatcher 510 includes an activation cable 530 coupled to actuator anchor point 16 to allow a user to mechanically control mechanical clutch 110.

It should be observed that the invention includes, but is not limited to, a novel structural combination of conventional computer processing components and computer hardware and software that may be embodied in a computer-readable medium, and not in particular detailed configurations thereof. Generally, the invention can be implemented flexibly in software, firmware, hardware and combinations of these as will be appreciated by those of ordinary skill in the art. Further, the invention is not limited to the particular embodiments depicted in the exemplary embodiments, but should be construed in accordance with the language in the claims.

We claim:

1. A mechanical clutch for use in a belt driven system requiring belt tensioning
a rotatable shaft;
a first pulley section rotationally and axially coupled to the central shaft;
a second pulley section rotationally coupled to the central shaft and moveable axially relative to the first pulley along the central shaft; and
an actuating mechanism that selectively imparts linear axial movement to the first pulley based on rotational input.

2. The clutch of claim 1, wherein the actuating mechanism is a ball ramp mechanism.

3. The clutch of claim 1, further comprising a rotating engine-driven shaft that drives the rotatable shaft to rotate.

4. The clutch of claim 1, further comprising a tool driving shaft driven that is driven by the rotatable shaft.

5. The clutch of claim 1, wherein the ball ramp mechanism includes an actuator plate that receives a rotational input.

6. The clutch of claim 5, wherein the ball ramp mechanism converts the rotational input into linear movement along the axis of the central shaft.

7. The clutch of claim 5, wherein the actuator plate is coupled to an electromechanical input providing the rotational input.

8. The clutch of claim 1, wherein the rotatable shaft is configured to receive a splined rotating shaft.
